(19) United States
(12) Patent Application Publication
(10) Pub. No.: US 2010/0332060 A1
(43) Pub. Date: Dec. 30, 2010

(54) POWER CONVERSION CONTROLLING METHOD OF FUEL CELL-BATTERY HYBRID-ELECTRIC VEHICLE AND CONTROL DEVICE

(75) Inventors: Joong Myeon Bae, Daejeon (KR); Dong Ryul Lee, Seoul (KR)

Correspondence Address: LRK Patent Law Firm, 1952 Gallows Rd, Suite 200, Vienna, VA, 22182, US

(73) Assignees: CT & T CO., LTD., Dangjin-gun (KR); KOREA ADVANCED INSTITUTE OF SCIENCE AND TECHNOLOGY, Daejeon (KR)

(21) Appl. No.: 12/595,475

(22) PCT Filed: May 21, 2007
(86) PCT No.: PCT/KR07/02462

§ 371 Date: Oct. 9, 2009

(51) Int. Cl. B60W 20/00; B60W 10/08; B60W 10/26; B60W 10/28

(52) U.S. Cl. 701/22; 903/903; 903/944

(57) ABSTRACT

The present invention relates to a method and apparatus for controlling power allocation of a fuel cell-battery hybrid system. A mode switching output value, which is a reference for switching of power supply status and power allocation, is set within a range below a maximum power value of a motor supplied with a constant voltage from the fuel cell and/or the battery. A requested output value is extracted in real time. The mode switching output value is compared with the requested output value. When the requested output value is less than the mode switching output value, a fuel cell converter is operated, and an operation of a battery converter is stopped. When the requested output value is equal to or greater than the mode switching output value, both the fuel cell converter and the battery converter are simultaneously operated in a predetermined output ratio.

### TECHNICAL FIELD

The present invention relates, in general, to a method and apparatus for controlling power allocation of a fuel cell-battery hybrid system, and, more particularly, to a method and apparatus for controlling power allocation of a fuel cell-battery hybrid system, which can switch over to different power supply methods according to a requested output value using a fuel cell and a battery, and can stably supply power to a motor.

### BACKGROUND ART

Generally, the term ‘hybrid’ when referring to vehicles means that two or more types of power are supplied to a vehicle. A hybrid vehicle uses a combination of two power sources, for example, an existing engine and a battery, the engine and a fuel cell, and a battery and a fuel cell, so that fuel, such as electricity, oil, and gas, can be more energy-efficiently used, and a pollution problem caused by the exhaust gas of vehicles can be solved, and thus research on the proper utilization of the hybrid vehicle has been actively conducted.

A fuel cell is operated depending on operating principles in which a material having activity, such as hydrogen, is oxidized through an electrochemical reaction, and chemical energy, released by such a process, is converted into electricity. Accordingly, when a pure fuel cell is applied to the power source of a vehicle, the case where the fuel cell deviates from a high-efficiency region thereof frequently occurs due to the output characteristics of maintaining optimal efficiency at output densities falling within a specific range, thus decreasing energy efficiency.

In order to overcome such a limitation in the application of a fuel cell, other supplementary energy sources capable of compensating for the output characteristics of the fuel cell are utilized in conjunction therewith. The prior art related to this is disclosed in Korean Patent No. 460881 entitled “System and Method for Controlling Power Allocation of Fuel Cell-Hybrid Electric Vehicle”, which is described in brief below.

The prior art has a construction including a fuel cell used as a main power source; a battery used as an auxiliary power source; a bidirectional DC/DC converter connected to the battery and configured to input or output power, an inverter electrically connected both to the fuel cell and to the bidirectional DC/DC converter; a motor connected to the inverter and configured to convert electric energy into the rotational kinetic energy required to drive a vehicle; and a control unit for estimating power requested by the vehicle and for controlling power transmission between the fuel cell, the battery, the bidirectional DC/DC converter, and the inverter on the basis of the estimated vehicle-requested power and the status of the fuel cell and the battery.

Further, the control unit is configured to execute any one selected from among a fuel cell mode that enables the energy of only the fuel cell to drive the motor; a battery discharging mode that enables the energy of both the fuel cell and the battery to simultaneously drive the motor; a battery charging mode that enables part of the energy output from the fuel cell to drive the motor and the remaining part thereof to charge the battery; and a regeneration mode that enables regenerative braking energy to charge the battery.

The prior art is intended to optimize energy allocation in consideration of the range of operation of the fuel cell and the status of the battery by suitably selecting one from among the above modes according to the circumstances, but there is a limitation in that, even only in the battery discharging mode in which the operation of the battery can be executed, the battery takes charge of only that part of the power which cannot be supplied by a fuel cell operating at maximum power.

As the battery takes charge of a small part of the power by assisting the fuel cell, the battery is dependent on the characteristics of the fuel cell itself, which cannot realize uniform performance at high power, so that the prior art still has a problem in that the supply of power cannot be stably performed in a region requiring high power, such as an acceleration region and a region in which a vehicle ascends a slope, or a region in which output power rapidly changes to high power.

Further, since the operation efficiency of the battery is not considered compared to the case where the energy use efficiency of the fuel cell is considered, the output portions of the fuel cell and the battery are not suitably allocated. Accordingly, it is difficult to suitably complement the use of a fuel cell with the use of a battery in a combined manner, thus making it impossible to improve the efficiency of energy allocation.

### DISCLOSURE OF INVENTION

### Technical Problem

Accordingly, the present invention has been made keeping in mind the above problems occurring in the prior art, and an object of the present invention is to provide a method and apparatus for controlling power allocation of a fuel cell-battery hybrid system, which suitably allocates the output portions of a fuel cell and a battery and uses the allocated output portions, thus more stably supplying high-output power and improving the efficiency of energy allocation.

### Technical Solution

In accordance with one aspect of the present invention to accomplish the above object, there is provided a method of controlling power allocation of a fuel cell-battery hybrid system, comprising a reference value setting step of setting a mode switching output value, which is a reference for switching of power supply status and power allocation between a fuel cell and a battery, within a range below a maximum power value of a motor supplied with a constant voltage from the fuel cell and/or the battery; a requested value extraction step of extracting an output value, requested by the motor, in real time during traveling; an output value comparison step of comparing the mode switching output value with the requested output value extracted from the motor in real time; a low-output switching step of, when the requested output value is less than the mode switching output value, operating a fuel cell converter, which supplies a constant voltage from the fuel cell to the motor, and stopping operation of a battery converter, which supplies a constant voltage from the battery to the motor; and a high-output switching step of, when the requested output value is equal to or greater than the mode switching output value, simultaneously operating both the fuel cell converter and the battery converter in a predetermined output ratio.

Preferably, the method may further comprise an output ratio setting step of setting an output allocation ratio of the fuel cell to the battery, which can be applied to a case where the fuel cell and the battery are simultaneously operated; and an output ratio adjustment step of adjusting a resistor on a voltage supply path from the fuel cell converter to the motor, thus adjusting a voltage in a preset output allocation ratio of the fuel cell to the battery.

Preferably, the mode switching output value may be a current value set in such a way that an average of power values requested by the motor under preset travel conditions, in which maintenance or variation of velocity, braking and an inclination angle is performed, is derived, an average current value is derived by dividing the average power by the constant voltage supplied from the fuel cell and the fuel cell converter, and the current value is set to a value exceeding the derived average current value.

Preferably, the requested output value may be a current value derived by dividing a power value requested in real time under travel conditions in which maintenance or variation of velocity, braking and an inclination angle is performed, by the constant voltage supplied from the fuel cell and the fuel cell converter.

Preferably, the output allocation ratio of the fuel cell to the battery may be a ratio of maximum available powers of the fuel cell and the fuel cell converter to the battery and the battery converter.

Preferably, the method may further comprise a battery charging step of supplying the voltage from the fuel cell to the battery and charging the battery.

In accordance with another aspect of the present invention, there is provided an apparatus for controlling power allocation of a fuel cell-battery hybrid system, comprising a fuel cell electrically connected to a motor to supply power to the motor; a battery electrically connected to the motor to allow the motor to be selectively supplied with power from the fuel cell or from both the fuel cell and the battery; a fuel cell converter installed on a connection path between the fuel cell and the motor so as to adjust to a certain level power supplied from the fuel cell to the motor; a variable resistor disposed on a connection path between the fuel cell converter and the motor so as to adjust power supplied from an outside of the fuel cell converter to the motor; a battery converter installed on a connection path between the battery and the motor so that power supplied from the battery to the motor is adjusted to a certain level, and electrically connected to a connection path between the variable resistor and the motor so that the fuel cell and the battery can supply power to the motor in a predetermined output ratio; and a control unit for performing adjustment by disconnecting a connection path between the battery and the motor in the connection path between the fuel cell and the motor when the output value requested by the motor is less than a preset reference output value.

### ADVANTAGEOUS EFFECTS

The present invention having the above construction is advantageous in that, when a high output above a mode switching output value is required, a fuel cell and a battery supply output voltages in a predetermined ratio, so that the output portions of the fuel cell and the battery are suitably allocated and used to complement the limitations of the output characteristics of the fuel cell and the battery, thus further improving the efficiency of energy allocation.

Further, the present invention is advantageous in that, when high output is being supplied, the fuel cell and the battery have uniform output portions, and thus the maximum allowable power of the fuel cell is reduced, and power can be stably supplied within a range of high output, and in that the portion of the fuel cell, which has limited weight and volume and is expensive, is reduced, and thus the lightweight, small size, and most proper utilization of the apparatus can be realized.

Further, the present invention is advantageous in that, since residual energy of the fuel cell can continuously charge a battery both in a low output mode and a high output mode, the supply of power can be continuously performed regardless of whether a requested output value is high or low during the operation of the fuel cell.

In addition, the present invention is advantageous in that, through a simple structure using a converter and a variable resistor, a mode, which enables only a fuel cell to be used, and a mode, which enables both the fuel cell and the battery to be used together in a preset output ratio, can be easily individually realized, and a control scheme, which enables switching and adjustment between respective modes to be performed on the basis of a preset output value and facilitates the adjustment of the output ratio of the fuel cell to the battery, can be easily implemented.

### BRIEF DESCRIPTION OF THE DRAWINGS

FIG. 1 is a flowchart showing a first embodiment of a method of controlling power allocation of a fuel cell-battery hybrid system according to the present invention;

FIG. 2 is a diagram showing the construction of an apparatus for controlling power allocation of a fuel cell-battery hybrid system according to the present invention;

FIG. 3 is a graph showing data corresponding to requested output values during traveling under designated travel conditions;

FIG. 4 is a graph conceptually showing the requested output and allocated output of the fuel cell and the battery; and

FIG. 5 is a graph showing data corresponding to requested output and allocated output of the fuel cell and the battery at a maximum power of 4 kw and a mode switching output value of 30A.

### BEST MODE FOR CARRYING OUT THE INVENTION

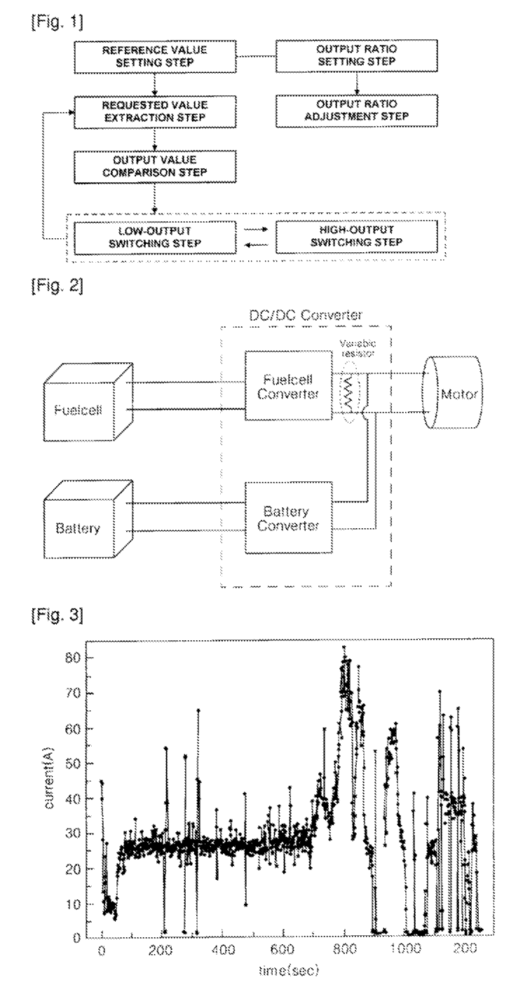

Hereinafter, embodiments of the present invention will be described in detail with reference to the attached drawings. FIG. 1 is a flowchart showing a first embodiment of a method of controlling power allocation of a fuel cell-battery hybrid system according to the present invention, and FIG. 2 is a diagram showing the construction of an apparatus for controlling power allocation of a fuel cell-battery hybrid system according to the present invention.

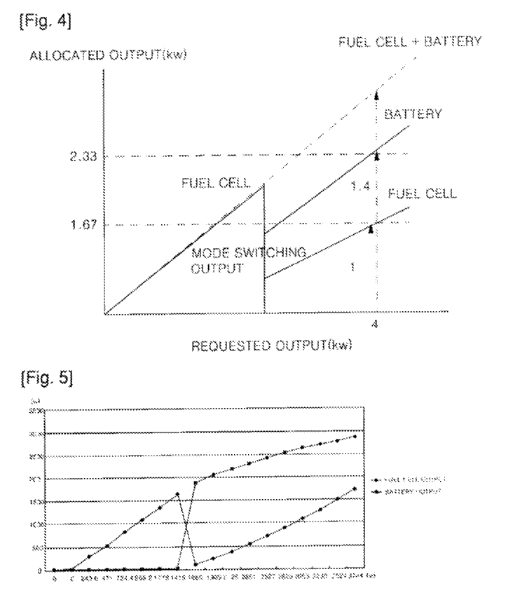

Further, FIG. 3 is a graph showing data corresponding to requested output values during traveling under designated travel conditions, FIG. 4 is a graph conceptually showing the requested output and allocated output of the fuel cell and the battery, and FIG. 5 is a graph showing data corresponding to requested output and allocated output of the fuel cell and the battery at a maximum power of 4 kw and a mode switching output value of 30A.

The method of controlling power allocation of a fuel cell-battery hybrid system according to the present invention mainly includes a reference value setting step, a requested value extraction step, an output value comparison step, a low-output switching step, and a high-output switching step. In the high output mode, the fuel cell and the battery are operated to have uniform output portions, and thus the travel performance of a compact electric vehicle for short-distance movement, which uses a motor, supplied with voltage from the fuel cell and the battery, as a main power source, can be improved upon.

The reference value setting step is the step of setting a mode switching output value, which is the reference required to switch the power supply status of the fuel cell and the battery to the low-output switching step or the high-output switching step. The mode switching output value must be set within a range below the maximum power of the motor, supplied with constant voltage, from the fuel cell, having a designated specification, and the battery.

The mode switching output value is a current value set in such a way that the average of power values requested by the motor for a preset period of time under preset travel conditions, in which the maintenance or variation of velocity, braking and an inclination angle is performed, is derived, an average current value is derived by dividing the average power by a predetermined voltage supplied to the motor through the fuel cell, having a designated specification, and a fuel cell converter, and the current value is set within a range above the average current value and below the maximum power of the motor.

FIG. 3 is a graph showing data corresponding to output values requested during traveling under preset travel conditions. An average current value of 28A can be derived by dividing power values checked at regular intervals by the predetermined output voltage of the fuel cell and the fuel cell converter. When the mode switching output value is set to a value less than 28A, the battery must be frequently charged. When the mode switching output value is 28A, mode switching frequently occurs, so that the fuel cell converter and the battery converter are excessively operated. Accordingly, under the travel conditions in which the data of FIG. 4 is obtained, the mode switching output value is preferably set to 30A, slightly higher than the average current value of 28A.

The requested value extraction step is the step of extracting an output value, requested by the motor during traveling, in real time. The requested output value is a current value obtained by dividing the power value, requested in real time during the actual traveling of a vehicle, by a constant voltage value supplied from the fuel cell, having a designated specification, and the fuel cell converter.

The output value comparison step is the step of comparing in real time the mode switching output value with the requested output value, extracted from the motor in real time. When the output value comparison step proceeds to low-output switching step or the high-output switching step, as shown in FIG. 1, the output value comparison step switches or proceeds to the low-output switching step when the requested output value is less than the mode switching output value, whereas the output value comparison step switches or proceeds to the high-output switching step when the requested output value is equal to or greater than the mode switching output value.

The low-output switching step is the step applied to the case where the requested output value is less than the mode switching output value, and is performed such that the fuel cell converter, which supplies a constant voltage from the fuel cell to the motor, is operated, and the battery converter, which supplies a constant voltage from the battery to the motor, is not operated, thus enabling voltage to be supplied from only the fuel cell.

The high-output switching step is the step applied to the case when the requested output value is equal to or greater than the mode switching output value. At this step, the fuel cell converter and the battery converter are simultaneously operated so that respective voltages are output in a predetermined ratio in which the maximum available powers of the fuel cell (and the fuel cell converter), having a designated specification, and the battery (and the battery converter) are considered.

When the voltages of the fuel cell and the battery are output in a predetermined ratio, the fuel cell and the battery can be simultaneously activated in an allocation ratio proportional to the output specifications of the fuel cell and the battery at the high-output switching step if the present invention includes an output ratio setting step of previously setting an output allocation ratio of the fuel cell to the battery to the ratio of the maximum power values of the fuel cell (and the fuel cell converter) to the battery (and the battery converter), and an output ratio adjustment step of adjusting the supply voltage provided by the fuel cell and the battery at the preset allocation ratio, output at the high-output switching step, by adjusting a resistance value on a voltage supply path from the fuel cell converter to the motor.

When high output is supplied, the fuel cell and the battery respectively occupy uniform output portions through the high-output switching step, and thus power can be stably supplied even in the range of high output while reducing the maximum allowable power of the fuel cell, and the light weight and small size of a hybrid vehicle can be realized by reducing the portion of the fuel cell having a limited weight and volume.

When the present invention further includes a battery charging step of supplying the voltage from the fuel cell to the battery and charging the battery, the fuel cell is operated within the range in which the maximum allowable power thereof is less than the maximum power both in the case where the fuel cell is operated alone at the low-output switching step, and in the case where both the fuel cell and the battery are operated at the high-output switching step. Accordingly, since the battery can be continuously charged using the residual energy of the fuel cell, the supply of power can be performed regardless of whether the requested output value is high or low during the operation of the fuel cell.

According to the present invention, when a high output equal to or greater than the mode switching output value is requested by the motor, the fuel cell and the battery supply output voltages in a predetermined ratio in proportion to respective output performances, thus complementing the output characteristics of the fuel cell having the limitation whereby performance is not maintained at high output, and the output characteristics of the battery having the limitation whereby it is difficult to operate the battery at high output for a long period of time. Accordingly, the efficiency of energy allocation can be improved compared to the conventional scheme in which energy allocation is performed with emphasis only on the function of the fuel cell.

Hereinafter, an apparatus for controlling power allocation of a fuel cell-battery hybrid system to implement the above-described power allocation control method of a fuel cell-battery hybrid system will be described.

The power allocation control apparatus of a fuel cell-battery hybrid system according to the present invention includes a fuel cell, a battery, a fuel cell converter, a variable resistor, a battery converter, and a control unit, and is configured to perform adjustment, such as by disconnecting a path along which power from the battery is supplied to the motor, or by electrically connecting the battery to the motor so that the battery, together with the fuel cell, can supply power in a predetermined ratio.

The fuel cell is electrically connected to the motor to supply power thereto, and the fuel cell converter is installed on the connection path between the fuel cell and the motor in order to adjust to a certain level the power supplied from the fuel cell to the motor.

The battery is electrically connected to the motor so that the motor can be selectively supplied with power from the fuel cell or from both the fuel cell and the battery. The battery converter is installed on the connection path between the battery and the motor to adjust to a certain level the power supplied from the battery to the motor.

Each of the fuel cell converter and the battery converter is implemented using a DC-DC converter, which has a structure in which an inductor functioning as a transformer coil is layered on a semiconductor circuit for controlling current, or a structure in which an inductor is arranged in parallel with a semiconductor circuit, and which functions to convert DC electricity, generated by the battery or the like, into DC voltages suitable for respective parts and to allocate the DC voltages.

The variable resistor is disposed on the connection path between the fuel cell converter and the motor in order to be capable of adjusting power supplied from the outside of the fuel cell converter to the motor. The end of a voltage supply path, extending from the battery converter to the motor, is electrically connected to the connection path between the variable resistor and the motor so as to allow both the fuel cell and the battery to supply power to the motor in a predetermined output ratio.

When the output value requested by the motor is less than the preset reference output value corresponding to the mode switching output value, the control unit disconnects the connection path between the battery and the motor in the connection path between the fuel cell and the motor, thus enabling only the fuel cell converter to be operated. When the output value requested by the motor is equal to or greater than the mode switching output value, the fuel cell and the battery are simultaneously operated in the voltage allocation ratio formed by the variable resistor.

When a motor having a maximum power of 4 kw, a fuel cell having a maximum rated power of 1.7 kw, and a battery having a maximum power of 2.4 kw are provided, and a mode switching output value of 30A, derived from the graph of FIG. 3, is applied, the requested output and allocated output of the fuel cell and the battery can be conceptually designated by applying an output ratio of 1:1.4 corresponding to the ratio of the maximum rated power of 1.7 kw of the fuel cell to the maximum power of 2.4 kw of the battery, within an output range above the mode switching output value and below the maximum power of 4 kw, as shown in FIG. 4.

FIG. 5 is a graph showing data corresponding to the requested output and allocated output of the fuel cell and the battery, which are actually measured while requested output is uniformly increased by applying a maximum power of 4 kw, a mode switching output value of 30A, a voltage of 47.8V, and a voltage ratio of 1:1.4 of the fuel cell to the battery. It can be seen that, in a range above a requested power of 1425 kw corresponding to the mode switching output value of 30A, the fuel cell and the battery output the power in a ratio of 1:1.3˜1.5.

The mode switching output value and the output ratio of the fuel cell to the battery are preferably applied as different values according to the travel conditions or device specifications, but may be simply adjusted using the fuel cell converter, the battery converter, and the variable resistor. Optimal efficiency can be found while different values are sequentially applied to the mode switching output value, and the adjustment of switching between modes can also be easily performed on the basis of the mode switching output value.

1. A method of controlling power allocation of a fuel cell-battery hybrid system, comprising:
a reference value setting step of setting a mode switching output value, which is a reference for switching of power supply status and power allocation between a fuel cell and a battery, within a range below a maximum power value of a motor supplied with a constant voltage from the fuel cell and/or the battery;
a requested value extraction step of extracting an output value, requested by the motor, in real time during traveling;
an output value comparison step of comparing the mode switching output value with the requested output value extracted from the motor in real time;
a low-output switching step of, when the requested output value is less than the mode switching output value, operating a fuel cell converter, which supplies a constant voltage from the fuel cell to the motor, and stopping operation of a battery converter, which supplies a constant voltage from the battery to the motor; and
a high-output switching step of, when the requested output value is equal to or greater than the mode switching output value, simultaneously operating both the fuel cell converter and the battery converter in a predetermined output ratio.

2. The method according to claim 1, further comprising:
an output ratio setting step of setting an output allocation ratio of the fuel cell to the battery, which can be applied to a case where the fuel cell and the battery are simultaneously operated; and
an output ratio adjustment step of adjusting a resistor on a voltage supply path from the fuel cell converter to the motor, thus adjusting a voltage in a preset output allocation ratio of the fuel cell to the battery.

3. The method according to claim 1, wherein the mode switching output value is a current value set in such a way that an average of power values requested by the motor under preset travel conditions, in which maintenance or variation of velocity, braking and an inclination angle is performed, is derived, an average current value is derived by dividing the average power by the constant voltage supplied from the fuel cell and the fuel cell converter, and the current value is set to a value exceeding the derived average current value.

4. The method according to claim 1, wherein the requested output value is a current value derived by dividing a power value requested in real time under travel conditions in which maintenance or variation of velocity, braking and an inclination angle is performed, by the constant voltage supplied from the fuel cell and the fuel cell converter.

5. The method according to claim 1, wherein the output allocation ratio of the fuel cell to the battery is a ratio of maximum available powers of the fuel cell (and the fuel cell converter) to the battery (and the battery converter).

6. The method according to claim 1, further comprising a battery charging step of supplying the voltage from the fuel cell to the battery and charging the battery.

7. An apparatus for controlling power allocation of a fuel cell-battery hybrid system, comprising:
a fuel cell electrically connected to a motor to supply power to the motor;
a battery electrically connected to the motor to allow the motor to be selectively supplied with power from the fuel cell or from both the fuel cell and the battery;
a fuel cell converter installed on a connection path between the fuel cell and the motor so as to adjust to a certain level power supplied from the fuel cell to the motor;
a variable resistor disposed on a connection path between the fuel cell converter and the motor so as to adjust power supplied from an outside of the fuel cell converter to the motor;
a battery converter installed on a connection path between the battery and the motor so that power supplied from the battery to the motor is adjusted to a certain level, and electrically connected to a connection path between the variable resistor and the motor so that the fuel cell and the battery can supply power to the motor in a predetermined output ratio; and
a control unit for performing adjustment by disconnecting a connection path between the battery and the motor in the connection path between the fuel cell and the motor when the output value requested by the motor is less than a preset reference output value.

8. The apparatus according to claim 7, wherein the fuel cell and the battery have an output ratio of 1:1.3˜1.5 under travel conditions in which the motor has a maximum power of 4 kw, the fuel cell has a maximum rated power of 1.7 kw, and the battery has a maximum power of 2.4 kw.

9. The method according to claim 2, further comprising a battery charging step of supplying the voltage from the fuel cell to the battery and charging the battery.
